(19) United States
(12) Patent Application Publication
(10) Pub. No.: US 2007/0073979 A1
(43) Pub. Date: Mar. 29, 2007

(54) Snoop processing for multi-processor computing system

(76) Inventor: Benjamin Tsien, Fremont, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/240,583

(22) Filed: Sep. 29, 2005

(51) Int. Cl. G06F 13/28

(52) U.S. Cl. 711/146

(57) ABSTRACT

A method is described that involves receiving, from a network, a snoop request at a network ordering point and storing the snoop request into a buffer. The snoop request is part of a transaction. The method also involves issuing the snoop request from the buffer and snooping a cache with the snoop request to generate a snoop response. The method also involves, after the snooping, determining if the snoop response's transaction is in conflict with another transaction.

### FIELD OF INVENTION

The field of invention relates generally to the computer sciences, and, more specifically, to a network ordering point for a multi-processor computing system.

### BACKGROUND

Prior art computing systems have typically used a “front side bus” between its one or more processors and its memory controller. FIG. 1 shows a traditional multi-processor prior art computing system. According to the depiction of FIG. 1, the front side bus 105 is a “shared medium” component in which electrical signals passed between any processor and any other processor and/or the memory controller 103 are carried over the same electrical wiring.

The front side bus 105 becomes a bottleneck, particularly for multi-processor systems, because there tends to be heavy communication over the front side bus 105 (through small communicative sessions called “transactions”) between the processors 101_1 through 101_4 and the memory controller 103 in order to effect “caching”. Caching involves the notion that frequently used data and/or instructions should be stored in a lower latency storage medium than the system memory 104. Fetching an item of data or an instruction from system memory 104 traditionally is a high latency transaction because, among other possible reasons, the system memory 104 is usually implemented with slower (but very dense) DRAM memory cells, and, has a more complicated access path (i.e., through the front side bus 105 and memory controller 103).

Therefore, caches 102_1 through 102_4 are positioned local to respective processors 101_1 through 101_4. By being positioned local to a processor (e.g., on the same die as the processor or being closely coupled to the processor) and by being implemented with faster SRAM memory cells, the latency of a processor's accessing of data and/or instructions in is own cache should be significantly less than the latency of accessing data and/or instructions in system memory 104.

Multi-processor systems, however, have some drawback in that: 1) a processor may access a data or instruction item that is cached in a cache that is local to another processor; and/or, 2) multiple copies of an item of data may exist in more than one cache. Both of these situations result in increased front side bus traffic (relative to single processor systems).

As such, in order to improve the performance of multi-processor systems, a new architecture has emerged in which the front side bus is replaced with a network containing bidirectional point-to-point links between the processors and memory controllers. FIG. 2 shows such an architecture. Here, note that the system nodes and memory controller are communicatively coupled by a network 205 having point-to-point links between these components. According to the architecture of FIG. 2, a “system node” is a unit containing one or more processing cores (e.g., one or more units of logic circuitry that executes program code), network ordering points 207, and cache controllers 206. Not shown on FIG. 2, a “system node” also may or may not incorporate the cache and memory controller on chip.

Of interest in these systems is the “transactions” that occur over the network 205 between the network ordering points and memory controller in system nodes to effect caching and shared access to the system memory. For example, as a basic case, consider a situation where two system nodes (e.g., system nodes 201_1 and 201_2) simultaneously request an item of data that happens to be cached in the cache local to system node 201_3. The requesting system nodes 201_1 and 201_2 do not know where the item of data is cached (if at all), and, therefore, issue requests to network ordering points at their three sibling system nodes (each request being referred to as a “snoop request”) as well as the home node 210 at the memory controller 203 for the item of data. The “home node” of the memory controller 203 is essentially the portion of the memory controller 203 that is responsible for handling the semantics of the transactions that the memory controller deals with over network 205.

With the desired item of data being cached in system node 201_3, a “conflict” will arise because two system nodes have simultaneously snooped for the same data item. Simultaneous in this sense is when one system node issues a transaction before another system node finishes its transaction to the same data. Hence, one of the system nodes will get the data first and both transactions in both system nodes will enter a conflict flow to allow the other system node to get the data. Here, each transaction (i.e., the snoop request from system node 201_1 and the snoop request from system node 201__2) can be viewed as being broken down into various phases including a “request” phase in which the snoop requests were entered into the network 205 and conflicts on the same data are detected, and a “conflict” phase in which the conflict for the common item of data is resolved. Accordingly, each of system nodes 201_1 and 201_2 will send a “conflict detected” response to the snoop request (a “snoop response”) to the home node after seeing each others' snoops and receive a “conflict phase initiation response” from the home node 210 in response to its request for the data item as notice that its transaction has entered the conflict phase.

Essentially, the network 205 supports a “transactional coherence” protocol (of which the snoop requests and conflict acknowledgements are a part) that permits transactions having phases as described above to be implemented within the network 205. As such, in order for each of the system nodes 201_1 through 201_4 and the memory controller 203 to behave consistently with this protocol, each of these components include logic circuitry, referred to as “network ordering point logic circuitry” that is responsible for implementing the semantics of the transactional coherence protocol and the order of coherence events in the network.

As discussed above, the network ordering point logic circuitry for the memory controller 203 can be referred to as the “home node”. The networking ordering point logic circuitry for the system nodes perform both “requestor” functions (i.e., functions associated with presenting a request onto network 205 that initiates a transaction) and “peer” functions (i.e., functions associated with responding to a request from a requestor). FIG. 2 shows the network ordering point logic circuitry for system node 201_1 as logic circuitry region 207. Note that one or more network ordering points 207 can be implemented per system node.

Moreover, the computing system also implements a “cache coherence” protocol. Cache coherence protocols, generally, are well understood in the art. A cache coherence protocol is essentially a definition of state assignments to items of cached information and a definition of state transitions based on actions taken in respect of the cached information, that, when followed, permits multiple instances of a same item of information (typically a “line” of cached information such as a line of cached data or a line of cached instructions) to be cached in different caches (e.g., a first instance of a particular line is cached in cache 202_1 and a second instance of the same line is cached in cache 202_2). These states typically include Modified (M), Exclusive (E), Shared (S) and Invalid (I).

In order to implement the cache coherence protocol, each of the system nodes include one or more cache controller that includes “cache ordering point logic circuitry” that is responsible for assigning states to cached lines of information in accordance with the state definitions and state transition definitions defined for the cache coherence protocol and for implementing the order of the cache events that cause these state transitions appropriate to the transactional coherence protocol. FIG. 2 shows this logic circuitry for system node 201_1 as logic circuitry region 206. Note that one or more cache ordering points can be implemented per system node.

### FIGURES

The present invention is illustrated by way of example and not limitation in the figures of the accompanying drawings, in which like references indicate similar elements and in which:

FIG. 1 shows a prior art multi-processor computing system having a front side bus;

FIG. 2 shows a prior art multi-processor system having a network of bidirectional point-to-point links in place of a front side bus;

FIG. 3 shows an architecture for combining networking operating point logic circuitry and cache ordering point logic circuitry;

FIG. 4 shows a request system node, a peer system node and a home node associated with a memory controller;

FIG. 5 shows a cache line state transition table.

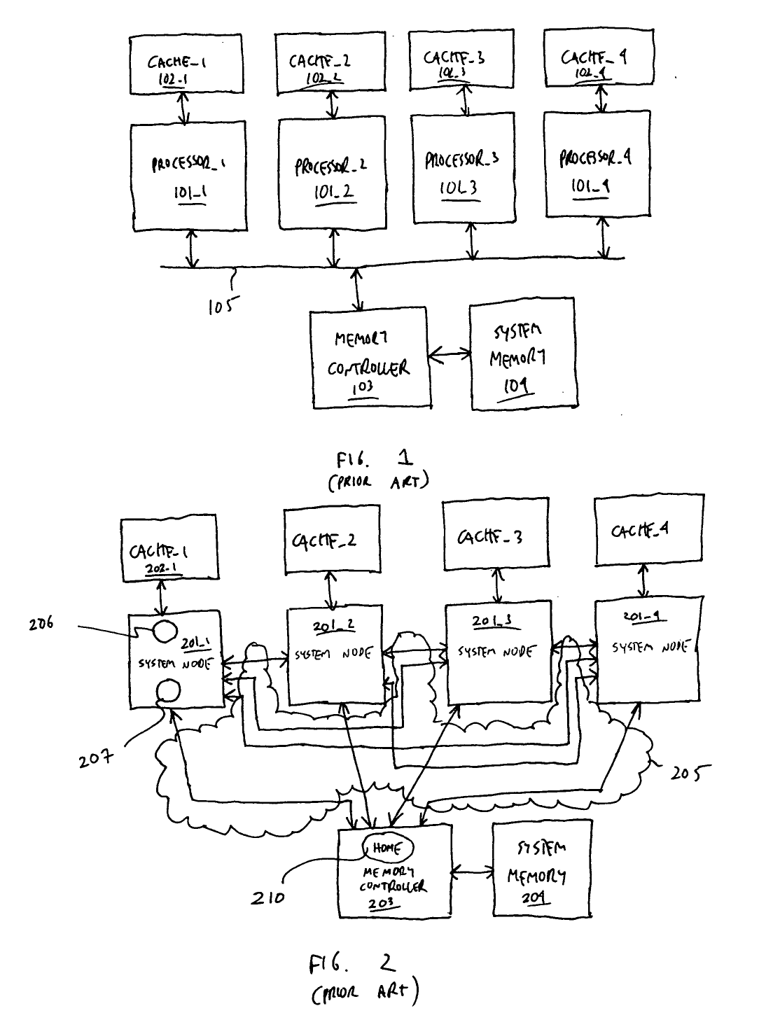

### DETAILED DESCRIPTION

In a bus based system, “conflicts” between transactions of different processors are generally avoided because a first processor will “seize” the bus in order to place its snoop request on the bus and a second processor will internally notice the conflict and prevent another snoop request for the same cache line from being presented on the bus (at least until the transaction associated with the first snoop request is completed). By contrast, in a network based system, two system nodes can issue snoop requests affecting a same cache line before either is aware of the other's snoop request.

As a consequence of the existence of such conflicts, in one embodiment, snoops in a network based system are blocked if a conflict is detected between it and an outstanding transaction at a peer that is in conflict phase. A pertinent architectural decision involves the relationship between a system node's network operating point and its cache ordering point. Specifically, should a system node's network ordering point decide to prevent a snoop response, on account of a conflict for the snoop requestor's transaction, before or after the snoop into the system node's cache is actually performed for the snoop request? If the later, the system node will “block” (i.e., prevent snooping into cache) any incoming snoop requests directed to a cache line involved in an outstanding transaction in conflict. If the former, the system node will “replay” a snoop (essentially, effect a “re-issue” of the snoop request back into the cache) if a flag is raised after the snoop into cache that the snoop request's corresponding transaction is in a conflict phase, thus, effectively making it appear like it was properly “blocked” in the network ordering point.

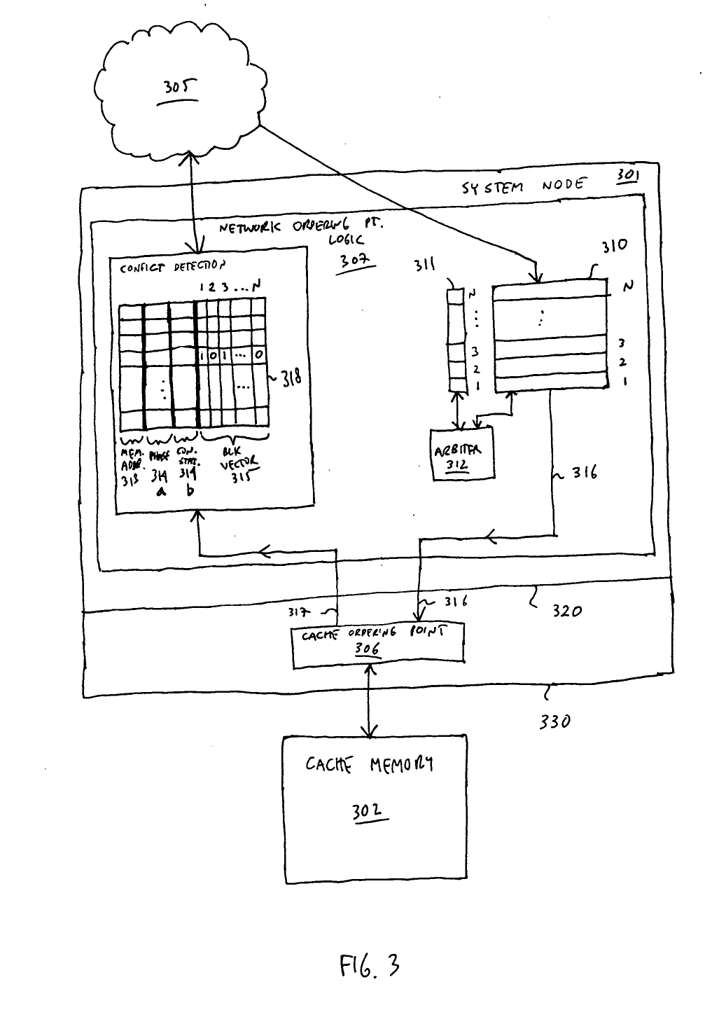

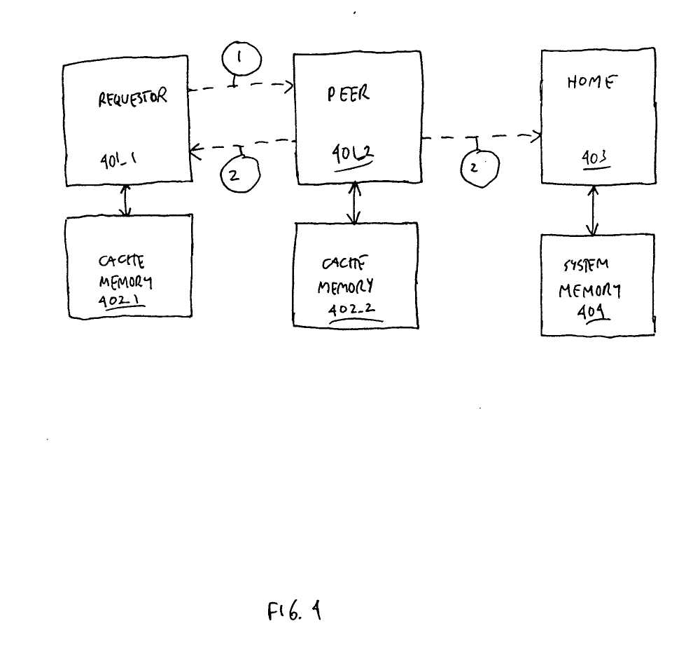

FIG. 3 shows an architecture for a design point that has chosen the former option (conflict flag raised for a snoop request after snoop into cache). Because of the existence of a replay mechanism, the network ordering point 307 includes a snoop buffer 310 that holds incoming snoop requests received from the network 305. When a snoop request first enters the snoop buffer 310 from network 305 it is free to be issued to the cache (i.e., no blocking is performed because no check is made into the conflict status of the snoop request's corresponding transaction). A copy of the snoop request is kept in the buffer 310 after the snoop request issues to cache, however, in case a conflict flag is raised for the snoop request subsequent to the snoop into cache being performed. If such a conflict flag is raised, the copy of the snoop request in buffer 310 is “re-played” into the cache at a later time. The copy of the snoop request remains in the buffer 310 until a snoop is performed into cache that is not subsequently flagged as having its associated transaction in a conflict phase. A more complete description of the processing is presented in more detail further below.

A relevant perspective of the architecture of FIG. 3 is that the cache ordering point logic circuitry 306 can be positioned remotely from a system node 301 that it communicates with. Architecturally speaking, if the system node corresponds to region 301 defined by edge 320, then, the communication lines 316, 317 into and out of the cache ordering point 306 could correspond to point-to-point links within network 305. Alternatively, if the system node corresponds to region 301 defined by edge 330, the communication lines 316, 317 would correspond to internal lines within the system node 301 (which themselves could merge into a bus). Moreover, cache memory 302 could be integrated onto the same semiconductor chip as the system node 301.

With respect to the operation of the architecture observed in FIG. 3, an incoming snoop request targeted for cache 302 is received from network 305 and entered into the snoop buffer 310. Here, snoop buffer 310 is depicted as having space for up to N snoop request entries. An “arbitration vector” 311 identifies which snoop request entries within the buffer 310 are free to issue to cache (e.g., the vector is implemented as a one hot encoded vector of dimension N in which a “1” in a specific bit position of the vector indicates that its corresponding entry in the buffer 310 is free to issue to cache, and, a “0” in a specific bit position of the vector indicates that its corresponding entry in buffer 310 is not free to issue to cache). When an incoming snoop request from network 305 is initially entered into buffer 310, its corresponding value in the arbitration vector 311 is set to a value that permits the snoop request to be issued to cache because conflict detection for the snoop request's transaction is not performed, hence, no blocking is performed.

Arbitration logic circuitry 312 is designed to choose a specific snoop request from amongst the snoop requests within the buffer 310 that are identified by the arbitration vector 311 as being available for issuance to the cache. In order to minimize the occurrence of a conflict and/or resolve an existing conflict, a system node's network ordering point logic circuitry 307 may “re-order” the issuance of snoop requests to cache to something other than a FIFO order based on the order in which the system node initially received the snoop requests from network 305. As such, the arbitration logic 312 is designed to comprehend the network's transaction protocol semantics sufficiently enough to intelligently select a snoop request from buffer 310 for issuance to cache, at perhaps the expense of keeping in buffer 310 snoop requests that entered buffer 310 prior to the selected snoop request, in order to enhance the likelihood of avoiding a transaction conflict situation.

Moreover, although not depicted in FIG. 3, the arbitration logic 312 could conceivably be designed to comprehend some sense of what the cache ordering point 306 is currently better able to handle (e.g., the size of the snoop request owing to network constraints in implementations where the cache or multiple interleaved cache controllers are coupled to the system node through a network), and, account for this information in its decision as to what snoop request is selected. Simply stated, the arbitration logic 312 can arbitrate between various network ordering point factors and/or cache ordering point factors in order to choose a specific snoop request from buffer 310.

After the arbitration logic circuitry 312 selects a specific snoop request that is free to issue to the cache, the selected snoop request will issue from the snoop buffer 310 and be presented to the cache ordering logic circuitry 306. The arbitration logic 312 also toggles the bit in the arbitration vector 311 that corresponds to the issued snoop request's entry so that the snoop request is no longer free to issue. As described in more detail below, “re-freeing” of the snoop request may be accomplished later if the snoop request's transaction is in conflict.

The cache ordering logic circuitry 306 effects the searching for the snoop request's corresponding cache line in cache memory 302 (a “hit” results if the cache line is found in cache memory 302, a “miss” results if the cache line is not found in cache memory 302). Note that the snooping activity could cause the cache ordering point logic circuitry 306 to change the state of the snooped node's (also known as a peer node) corresponding cache line (e.g., from E to I if the snoop request corresponds to a request that desires exclusive ownership of the cache line). The cache ordering logic circuitry at the requestor node will also separately update its cache state upon receiving a data response for the transaction.

The snoop result from cache (i.e., the snoop response) is returned by the cache ordering point logic circuitry 306 to the network ordering point logic circuitry 307 (at output 317). The portion of the network ordering point logic 307 that actually keeps track of conflicts within the network 305 manifests its knowledge, according to one approach, in tabular form 318 that identifies each transaction (e.g., memory address column 313, which may be implemented with memory such as a Content Addressable Memory (CAM) to detect matching conflicts), the phase status of the transaction (phase status column 314a), whether or not a conflict exists for that transaction (conflict status column 314b) and which entries in the buffer 310 correspond to snoop requests for that transaction (block vector 315). Presumably, each snoop response from the cache ordering point 306 has some kind of identifier (e.g., the memory address itself or a reference to lookup the address) that enables the network ordering point 307 to associate the snoop response with some specific row in the table 318.

If the snoop response from cache ordering point 306 does not match against any outstanding transaction, it is permitted to enter network 305 and its entry in buffer 310 is cleared. If it matches, but the transaction is not in conflict phase, it is permitted to enter network 305, its entry in buffer 310 is cleared, and additionally, the conflict status is marked to cause the transaction to transition to conflict phase later. If the snoop response from the cache ordering point 306 finds a matching transaction in conflict phase, the block vector is updated for the transaction. In an implementation, the data structure that issues from the snoop buffer 310 as the snoop request includes some identifier of the snoop buffer entry from which the snoop request issued. If a conflict phase conflict exists for the transaction to which the snoop response generated from a particular snoop request issue from buffer 310 pertains, a bit is set in the block vector 315 for that transaction that identifies the snoop buffer 310 entry from which the snoop request issued. Essentially, in an implementation, the block vector 315 is similar to the arbitration vector 311 in that it takes the form of a one hot encoded vector where each vector bit position corresponds to a different buffer entry position.

In contrast to the arbitration vector 311 however (which indicates which snoop request entries in the buffer are free to issue), the block vector 315 indicates which snoop request entries in the buffer 310 belong to the block vector's corresponding transaction. Thus, if a “stream” of snoop responses are issued from the cache ordering point logic 306 for the same transaction in conflict, the block vector will be updated for each snoop response in the stream to reflect its position in the buffer 310. Snoop responses from cache ordering point 306 that are associated with a transaction in conflict are essentially “killed” by the network ordering point logic 307 once the block vector for the transaction is updated (because, in a sense, they would have been “blocked” if the conflict for the snoop requests was flagged before cache snooping).

Eventually, the conflict for the transaction will be resolved and its associated block vector will be logically merged with the arbitration vector (e.g., logically ORed if the arbitration and blocking vectors use positive logic) to produce a new arbitration vector 311 that “frees” the snoop requests again. All conflict information in the now completed transaction will be erased. At this point, the arbitration logic 312 is free to select any one of them for issuance, irrespective if the snoop request was a replay vs. a first time issue. When any one of these snoop requests is selected for re-issuance to cache, and its corresponding transaction is not in conflict upon its snoop response being provided by the cache ordering point, the snoop response is permitted to enter network 305 and its corresponding snoop request in buffer 310 is cleared.

It is worth mentioning that “starvation” issues may arise as a consequence of the complexities associated with: 1) the “possibility” of a conflict at arising at “any time”; and, 2) the re-ordering function of the arbitration logic. Starvation is the failure to eventually put a snoop response into network 305 for a particular snoop request. For instance, each time a snoop is performed for a particular snoop request, a “new” conflict could arise for the snoop request's transaction, and, the nature of the new conflict could cause the snoop request to get “shuffled back” in the order in which the transaction's snoop requests are issued on the next playback. A repeated sequence of these events could cause the snoop request to never be successfully responded to.

According to one approach, a snoop request's “allocation” into buffer 310 is commensurate with formal recognition of the snoop request's reception from the network 305 by the network ordering point logic 307. In an embodiment, when a transaction's snoop requests are in replay, the network ordering point logic refuses to allocate into buffer 310 (or, from another perspective, formally recognize the arrival of) any new requests that could result in a conflict being declared across the new transaction and the snoop requests in replay. This ensures that a “new” conflict will not be detected during the replay processing.

Another issue concerns any violation of the cache coherence protocol when a conflict is detected for a snoop response. Specifically, recall that the snooping activity into cache could cause the cache ordering point logic circuitry 306 to change the state of the snoop request's corresponding cache line (e.g., from E to I if the snoop request corresponds to a remote requester that desires exclusive ownership of the cache line). If a conflict is later detected for the snoop response, the state of the corresponding cache line may be excessively downgraded, because, according to the combined import of the network and cache ordering points, the snoop was not supposed to have happened in the first place. However, this effect is benign in one embodiment and does not affect the overall coherency of the multiprocessor system, as these silent cache downgrade transitions are allowed in the protocol for E, S, and F states, and downgrades are allowed from M as long is data is written back to memory.

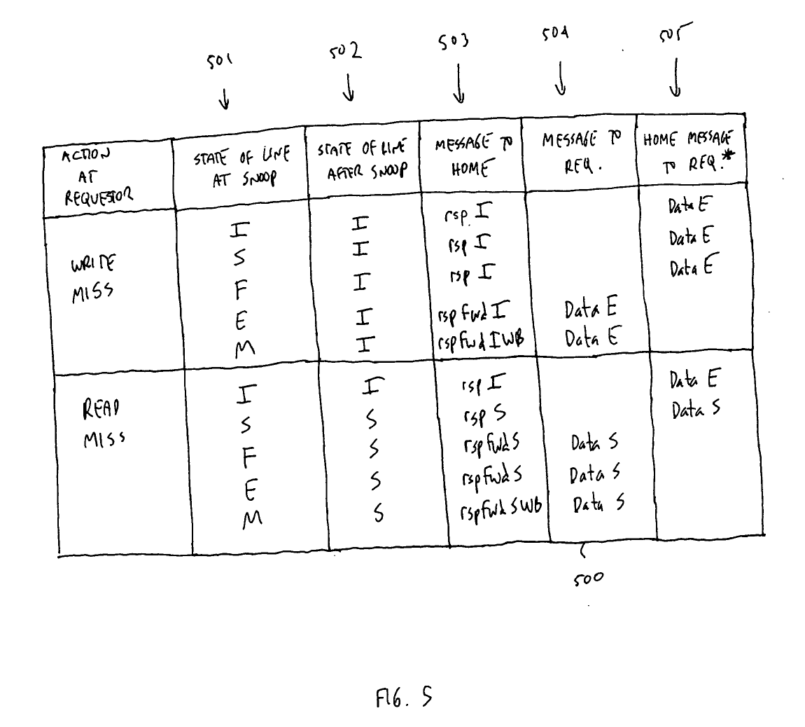

FIG. 4 shows a multiprocessor system model and FIG. 5 shows cache line state tables 500 for analyzing cache line state issues associated with conflict detection subsequent to a snoop into cache for a particular transaction. The table in FIG. 5 assumes cache misses in all other peers besides peer 401_2. According to FIG. 4 and the “Write Miss” row in the state tables 500 of FIG. 5, a first system node 401_1 snoops into its own cache 402_1 in search of cache line of data that it wishes to write to. The cache snoop results in a miss (i.e., the desired cache line is not found in cache 402_1). As such, at 1 of FIG. 4, system node 401_1 initiates a transaction by sending into the network a snoop request to another system node 401_2 for the cache line. Hence, system node 401_1 is referred to as the “requestor” or “request system node”. System node 401_2 is referred to as the “peer” system node because it may have the desired cache line in its own cache 402_2.

According to this example, the request sent by system node is a “request for exclusive ownership” of the cache line because it intends to write to it. This corresponds to a cache line in the Exclusive or “E” state. Exclusive ownership of the cache line by system node 401_1 means that any other cached copies of the cache line in the system (e.g., in cache 402_2) will need to be invalidated (i.e., put into the “I” state) because system node 401_1 is supposed to be the only system node having a “valid” instance of the cache line. Here, the underlying theory of operation is that since system node 401_1 intends to change the cache line's data (by writing to it), the version maintained by system node 401_1 is essentially the latest, updated version of the cache line. As such, all other copies in the system will be “stale”, and, no other system nodes should attempt to write to the same cache line. Therefore exclusive ownership of the cache line by system node 401_1 and invalidation of all other instances of the cache line in the system is warranted.

Columns 501 through 505 depict certain behaviors if the snoop for the requested cache line by peer system node 401_2 into cache 402_2 is a “hit” (i.e., the peer system node's cache 402_2 has a copy of the requested cache line). According to the behaviors depicted in the cache tables 500 for the Write Miss situation, the peer system node 401_2 will forward its copy of the cache line in cache 402_2 if its copy is either in the exclusive state (E) or in the modified state (M). In all other cases (i.e., the cache line instance in cache 402_2 is in the Invalid state (I), the Shared state (S), or the Forwarding state (F)), the cache line instance will be provided by the memory controller 403 from its version of the cache line in system memory 404 (here, the request sent at 1 by the request system node 401_1 can be assumed to have had a sibling request for the cache line sent to the memory controller 403—thus the memory controller 403 is aware of the request system node's desire for the cache line).

Columns 501 and 502 represent the state transition imparted upon the cache line instance in cache 402_2 as a consequence of the snoop hit in cache 402_2. Note that, consistent with the theory of operation described just above, these columns reveal that regardless of what state the cache line was in before the snoop (column 501), after the snoop (column 502), the cache line in cache 402_2 will be in the I state. Columns 503 and 504 describe messages sent by the peer system node 401_2 to the memory controller 403 and request system node 401_1, respectively (also shown as 2A and 2B respectively in FIG. 4), in response to the particular cache line state found in cache 402_2.

If the cache line instance was in the I, S or F states at the time of the snoop, as seen in column 503 the peer system node 402_2 will send a “rspl” message to the memory controller 403 (which informs the memory controller 403 that system node 401_2 has invalidated its copy of the cache line), and, as seen in column 505, the memory controller 403 will directly respond to the requesting system node's request by sending its version from system memory 404 in an exclusive state (“DataE”). In these cases there is no problem caused by the state change to the cache line in cache 402_2 if a conflict is detected with another transaction because, according to the transaction associated with the snoop request sent by system node 401_1, the memory controller 403 will provide the cache line to the requesting system node 401_1 and the cache line state is ultimately expected to reach the I state anyway.

However, note that if the cache line is in either of the E or M states, the peer system node 401_2 responds to the snoop request by sending the cache line from cache 402_2 to the requesting system node 401_2 in the exclusive state (DataE in column 504). That is, unlike the I, S or F states, the cache line provided to the requesting system node 401_1 is from cache 402_2 rather than system memory 404. If the cache line was in the E state, the peer system node 401_2 also notifies the memory controller 403 that it has forwarded the cache line to the requesting system node 401_1 and has invalidated its own copy in cache 402_2 (“rspFwdl” in column 503). If the cache line was in the M state, the peer system node 401_2 notifies the memory controller 403 that it has forwarded the cache line to the requesting system node 401_1, has invalidated its own copy in cache 402_2, and forwards a copy of its version of the cache line in cache 402_2 to the memory controller 403 so that the memory controller 403 can “write-back” this version into system memory 404 (“rspFwdlWB” in column 503).

If the cache line in cache 402_2 was in the E or M states when the snoop into cache 402_2 occurred, and if the snoop then conflicts with an outstanding transaction in conflict phase, then the snoop will need to be killed and replayed and made to appear like it was blocked during the conflict phase. However, the fact that it was issued once before being blocked meant that the cache line now was put in the I state by the cache ordering logic as a consequence of the snoop having been performed. In this case, special “hooks” are designed into the logic circuitry of the network ordering point to recognize the situation and take special action.

According to one approach, if the cache line existed in the E state at the time of the snoop, the peer system node 402_2 does not follow the semantics observed in tables 503, 504 for the E state and simply “pretends” that the cache line was in the I, S or F states. Here, it is assumed that whenever a cached cache line exists in the E state, a duplicate copy of that cache line exists in system memory 404. By pretending the cache line was in the I, S or F state, the memory controller 403 will respond to the request rather than the peer system node 401_2, and, the extra and early invalidation of the cache line in cache 402_2 does not offend the state of the system.

According to another approach, if the cache line existed in the M state at the time of the snoop, a dangerous situation exists because the only copy of the most recently updated version of the cache line in the system resides in the network ordering logic of the peer system node 401_2. In an embodiment, the cache line is kept in a buffer (or other memory and/or register implemented structure such as table 318) within the network ordering point logic circuitry, and, the peer system node 402_2 again does not follow the semantics observed in tables 503, 504 for the M state and instead both the data and the snoop “wait” for the conflicting transaction that is already in conflict phase to be resolved. In an implementation, resolution of the conflict is signified by a “Cmp” message sent by the memory controller 403. In the same embodiment, the arrival of the “Cmp” message is not dependent on the processing of blocked snoops.

After the conflict is resolved (e.g., after the peer system node receives a Cmp message from the memory controller 403), the peer system node 402_2 sends the initially snooped cache line to the memory controller 403 which writes it back into system memory 404 (later snooped versions of the cache line will already be in the I state). The memory controller 403 then responds to the requesting system node's request by sending to the requesting system node 402_1 the updated version in system memory 404 in the E state. The invalidation of the cache line in cache 402_2 does not offend the system because of the exclusive ownership of the cache line by the requesting system node 401_1. One type of Cmp message could indicate that the memory controller 403 desires the peer system node's version of the cache line (a “CmpFwd” message). In this case, the peer system node sends the updated version of the cache line as a write back, but, also informs the memory controller that the second snoop into cache 402_2 triggered by the CmpFwd message resulted in an Invalid state (“RsplWB”).

The second row in the tables 500 of FIG. 5 is for a “Read Miss”. In the case of a Read Miss, the requesting system node 401_1 has tried to read a specific cache line in its own cache 402_1 but a cache miss resulted. As a consequence, a snoop request is sent to the peer system node 401_2. In cases where no other conflicting transactions exist and a hit occurs in cache 402_2, referring to columns 502 through 505, the peer system node 401_2: 1) if the cache line was in the I state at the time of the snoop into cache 402_2, notifies the memory controller that its copy was invalid (rspl in column 503) so that the memory controller will respond to the request (DataE in column 505); 2) if the cache line was in the S state at the time of the snoop into cache 402_2, notifies the memory controller that its copy was shared (“rspS” in column 503) so that the memory controller will respond to the request (DataS in column 505); 3) if the cache line was in the F or E states at the time of the snoop into cache 402_2, responds to the snoop request by sending the cache line found in cache 402_2 to the requesting system node 401_1 (DataS in column 504) and notifies the memory controller of its action (rspFwdS″ in column 503); 5) if the cache line was in the M state at the time of the snoop into cache 402_2, responds to the snoop request by sending the cache line found in cache 402_2 to the requesting system node 401_1 (DataS in column 504), notifies the memory controller of its action and sends its version of the cache line to the memory controller so that the memory controller can write-back this version into system memory (rspFwdSWB″ in column 503). Here, because a read is being performed and not a write, the cache line state is changed to a shared state (i.e., unlike a Write Miss, no change to the data takes place during a read so exclusive ownership is not needed). Note that the F state is a special state that permits a peer system node (rather than the memory controller) to provide a cache line in the shared state.

Considering the cases where the snoop conflicts with an outstanding transaction in conflict phase by the network ordering logic of system node 401_2 after the snoop into cache 402_2, the following situations may be made to apply. Firstly, in cases 1) and 2) above (cache line in I or S states), the peer system node is permitted to behave as described just above because the memory controller 403 responds to the request. In case 3) above (cache line in F or E states), the peer system node “pretends” that the cache line was in the I or S states so that the memory controller 403 responds to the request rather than the peer system node 401_2. Again, the system is assumed to be designed such that, if a cached cache line exists in the S state, a duplicate copy exists in system memory. In case 4) above (cache line in M state) state, again, a dangerous situation exists because the most recent, updated version of the cache line is within the network ordering point of peer system node 402_2. In this case, essentially, the same procedures described above for the Write Miss are performed for the Read Miss (wait for conflict resolution and respond with write back version to the memory controller).

Note also that embodiments of the present description may be implemented not only within a semiconductor chip but also within machine readable media. For example, the designs discussed above may be stored upon and/or embedded within machine readable media associated with a design tool used for designing semiconductor devices. Examples include a circuit description formatted in the VHSIC Hardware Description Language (VHDL) language, Verilog language or SPICE language. Some circuit description examples include: a behaviorial level description, a register transfer level (RTL) description, a gate level netlist and a transistor level netlist. Machine readable media may also include media having layout information such as a GDS-II file. Furthermore, netlist files or other machine readable media for semiconductor chip design may be used in a simulation environment to perform the methods of the teachings described above.

Thus, it is also to be understood that embodiments of this invention may be used as or to support a software program executed upon some form of processing core (such as the Central Processing Unit (CPU) of a computer) or otherwise implemented or realized upon or within a machine readable medium. A machine readable medium includes any mechanism for storing or transmitting information in a form readable by a machine (e.g., a computer). For example, a machine readable medium includes read only memory (ROM); random access memory (RAM); magnetic disk storage media; optical storage media; flash memory devices; etc.

In the foregoing specification, the invention has been described with reference to specific exemplary embodiments thereof. It will, however, be evident that various modifications and changes may be made thereto without departing from the broader spirit and scope of the invention as set forth in the appended claims. The specification and drawings are, accordingly, to be regarded in an illustrative rather than a restrictive sense.

1. A method, comprising:
receiving, from a network, a snoop request at a network ordering point and storing said snoop request into a buffer, said snoop request being part of a transaction;
issuing said snoop request from said buffer;
snooping a cache with said snoop request to generate a snoop response; and,
after said snooping, determining if said snoop response's transaction is in conflict with another transaction.

2. The method of claim 1 further comprising sending said snoop response into said network if said snoop response's transaction is not in conflict with another transaction.

3. The method of claim 1 further comprising refusing to send said snoop response into said network if said snoop response's transaction is in conflict with another transaction.

4. The method of claim 3 wherein said snoop request remains in said buffer after said issuing.

5. The method of claim 4 wherein said snoop request is replayed by re-issuing said snoop request from said buffer and re-snooping said cache with said snoop request to generate a second snoop response.

6. The method of claim 5 further comprising, if a cache line that said snoop request pertains to was in an E or F state during said snooping, said network ordering point behaving as if said cache line was instead in a state during said snooping selected from the group consisting of:
I; and,
S.

7. The method of claim 5 further comprising, if a cache line that said snoop request pertains to was in an M state during said snooping, said network ordering point buffering said snoop response and waiting for said conflict to be resolved and exited.

8. The method of claim 7 further comprising sending said snoop response to a home node after said conflict is exited so that said snoop response will be written back into a system memory, said exit of said conflict indicated by a message received at said network ordering point logic, said message one of:
a completion message; and,
a completion-forward message.

9. The method of claim 1 wherein said issuing further comprises issuing said snoop request from said buffer before one or more other snoop requests that arrived to said network ordering point, and were placed into said buffer, prior to said snoop request.

10. A semiconductor chip, comprising:
one or more processing cores;
networking ordering point logic circuitry to provide said one or more processing cores access to a network, said network ordering point comprising:
a buffer to store a snoop request received from said network;
an output to a cache ordering point coupled downstream from said buffer, said output to provide said snoop request to said cache ordering point;
an input from said cache ordering point to receive a snoop request generated from said snoop request;
logic circuitry coupled to said input, said logic circuitry to check if said snoop response's transaction is in a conflict phase.

11. The semiconductor chip of claim 10 further comprising said second logic circuitry to implement said cache ordering point.

12. The semiconductor chip of claim 10 further comprising arbitration logic circuitry coupled to said buffer to determine which of a plurality of snoop requests in said buffer are to be sent to said cache ordering point.

13. The semiconductor chip of claim 10 wherein said networking ordering point logic circuitry further comprises circuitry to hold a vector that indicates which snoop requests in said buffer are available to issue to said cache ordering point.

14. The semiconductor chip of claim 10 wherein said networking ordering point further comprises circuitry to hold a vector that indicates which snoop request within said buffer pertain to a particular transaction.

15. An apparatus, comprising:
one or more processing cores;
networking ordering point logic circuitry to provide said one or more processing cores access to a network, said network ordering point comprising:
a buffer to store a snoop request received from said network;
an output to a cache ordering point coupled downstream from said buffer, said output to provide said snoop request to said cache ordering point;
an input from said cache ordering point to receive a snoop request generated from said snoop request;
logic circuitry coupled to said input, said logic circuitry to check if said snoop response's transaction is in a conflict phase; and,
a point to point link coupled to said networking ordering point logic circuitry, said point to point link coupling said one or more processing cores to another one or more processing cores.

16. The apparatus of claim 15 further comprising said second logic circuitry to implement said cache ordering point.

17. The apparatus of claim 15 further comprising arbitration logic circuitry coupled to said buffer to determine which of a plurality of snoop requests in said buffer are to be sent to said cache ordering point.

18. The apparatus of claim 15 wherein said networking ordering point logic circuitry further comprises circuitry to hold a vector that indicates which snoop requests in said buffer are available to issue to said cache ordering point.

19. The apparatus of claim 15 wherein said networking ordering point further comprises circuitry to hold a vector that indicates which snoop request within said buffer pertain to a particular transaction.
